(19) United States
(12) Patent Application Publication
(10) Pub. No.: US 2019/0276586 A1
(43) Pub. Date: Sep. 12, 2019

(54) HIGH HEAT COMPOSITE COMPOSITIONS, ARTICLES, AND USES THEREOF

(71) Applicant: SABIC GLOBAL TECHNOLOGIES B.V., BERGEN OP ZOOM (NL)

(72) Inventors: EDWARD NORMAN PETERS, Lenox, MA (US); PRAKASH SISTA, Evansville, IN (US)

(21) Appl. No.: 16/333,009

(22) PCT Filed: Mar. 10, 2017
(86) PCT No.: PCT/US2017/021797

§ 371 Date: Mar. 13, 2019

Related U.S. Application Data
(60) Provisional application No. 62/399,856, filed on Sep. 26, 2016.

(51) Int. Cl. C08G 59/24; C08G 59/26; C08G 59/50; C08J 5/04; C08J 5/24; C08L 63/10

(52) U.S. Cl. CPC C08G 59/245; C08G 59/26; C08G 59/5033; C08J 2363/00; C08J 5/24; C08L 63/10; C08J 5/042

(57) ABSTRACT

A high heat epoxy composite including a substrate; a matrix composition comprising: a high heat epoxy compound, and a hardener, wherein the matrix composition comprises 20 to 40 total weight percent of the composite; and wherein a cured sample of the matrix composition has a glass transition temperature of greater than or equal to 200 C; and a cured, laminated sample of the composite has a flexural strength of greater than 850 MPa measured as per ASTM D7264; and a flexural modulus of greater than 65 GPa measured as per ASTM D7264 is provided.

### CROSS-REFERENCE TO RELATED APPLICATIONS

This application claims priority to U.S. provisional application Ser. No. 62/399,856, filed Sep. 26, 2016, the contents of which are hereby incorporated by reference.

### BACKGROUND

Polymer-reinforced fiber composite materials, such as sheets and tapes, are used in a variety of applications. The polymers used in composite materials have many functions, including holding the fibers in place, protecting the fibers from the environment, and providing good aesthetics. The polymers used in composite materials can also deform and distribute stress applied to the fibers, improve impact and fracture resistance of the composite, enhance transverse properties of the laminate, and carry interlaminar shear. Polymers used in matrix materials for applications desirably have high glass transition temperature, low moisture absorption, low shrinkage, and good fracture toughness.

Epoxy polymers are used in a wide variety of applications including protective coatings, adhesives, electronic laminates, flooring and paving applications, glass fiber-reinforced pipes, and automotive parts. In their cured form, epoxy polymers offer desirable properties including good adhesion to other materials, excellent resistance to corrosion and chemicals, high tensile strength, and good electrical resistance. However, cured epoxy polymers can be brittle and lack toughness.

There is a need for epoxy-based composite materials with improved properties.

### SUMMARY

A high heat epoxy composite comprises: a substrate; a matrix composition comprising a high heat epoxy compound having a formula:

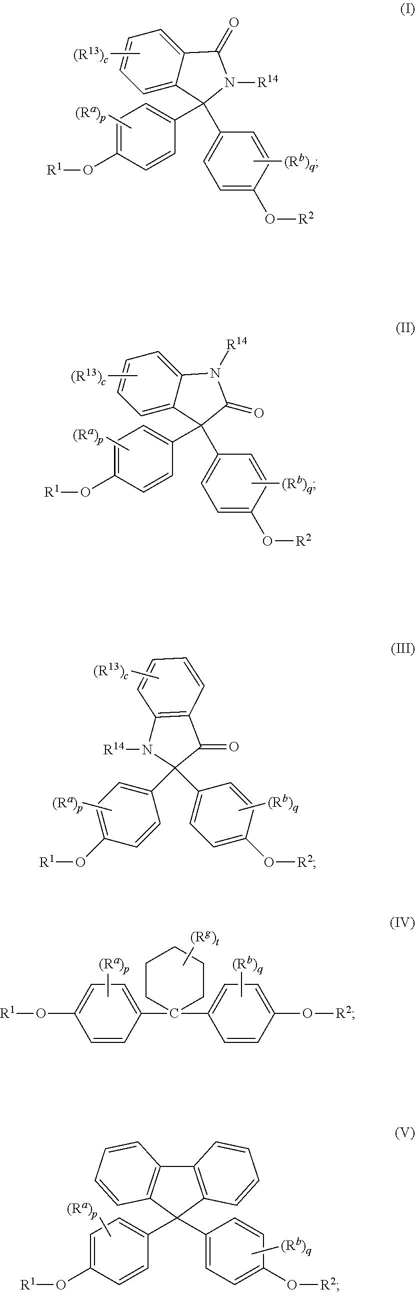

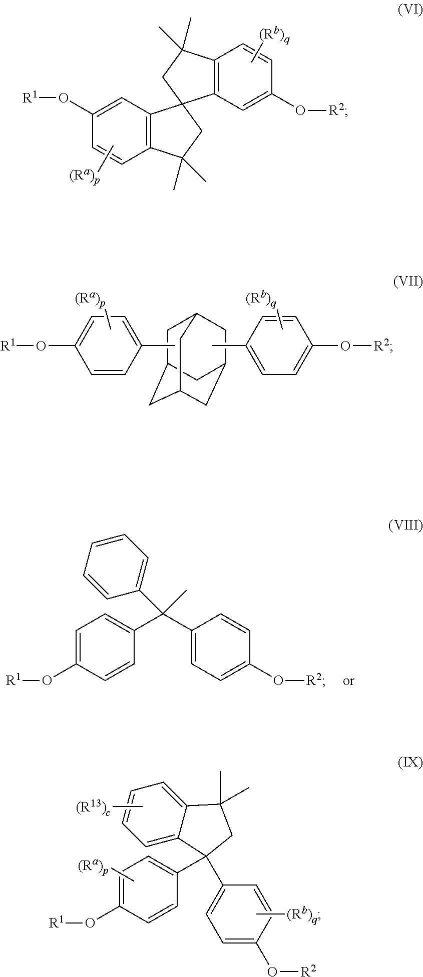

wherein R¹ and R² at each occurrence are each independently an epoxide-containing functional group; R^{a} and R^{b} at each occurrence are each independently halogen, C₁-C₁₂ alkyl, C₂-C₁₂ alkenyl, C₃-C₈ cycloalkyl, or C₁-C₁₂ alkoxy; p and q at each occurrence are each independently 0 to 4; R¹³ at each occurrence is independently a halogen or a C₁-C₆ alkyl group; c at each occurrence is independently 0 to 4; R¹⁴ at each occurrence is independently a C₁-C₆ alkyl, phenyl, or phenyl substituted with up to five halogens or C₁-C₆ alkyl groups; R^{g} at each occurrence is independently C₁-C₁₂ alkyl or halogen, or two R^{g} groups together with the carbon atoms to which they are attached form a four-, five, or six-membered cycloalkyl group; and t is 0 to 10; and a hardener; wherein the matrix composition comprises 20 to 60 total weight percent of the composite, preferably 20 to 40 total weight percent, preferably 30 to 50 total weight percent of the composite; and wherein a cured sample of the matrix composition has a glass transition temperature of greater than or equal to 200° C.; and a cured, laminated sample of the composite has a flexural strength of greater than 850 MPa measured as per ASTM D7264; and a flexural modulus of greater than 65 GPa measured as per ASTM D7264 is provided.

A method of manufacturing a high heat, epoxy prepreg comprises coating a substrate, preferably carbon fibers, with a matrix composition comprising a compound having a formula:

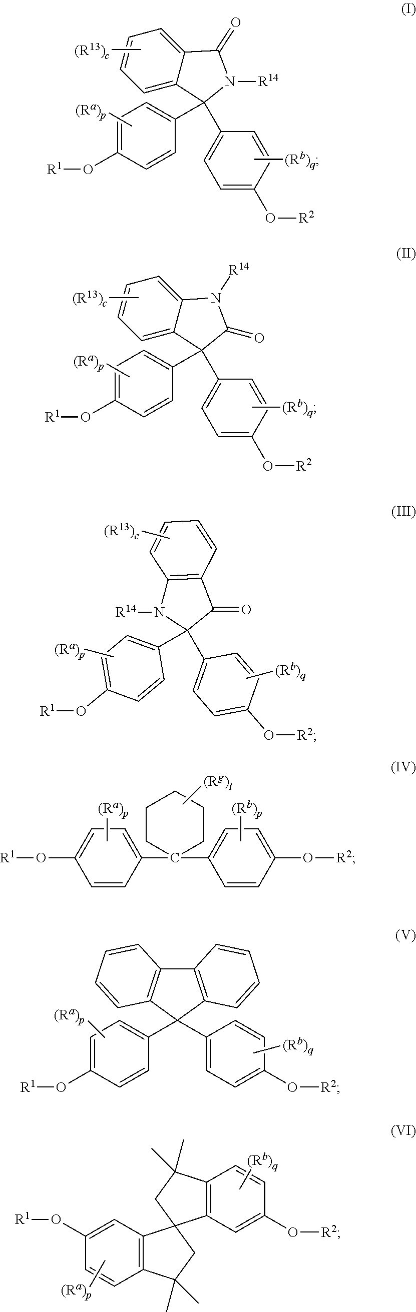

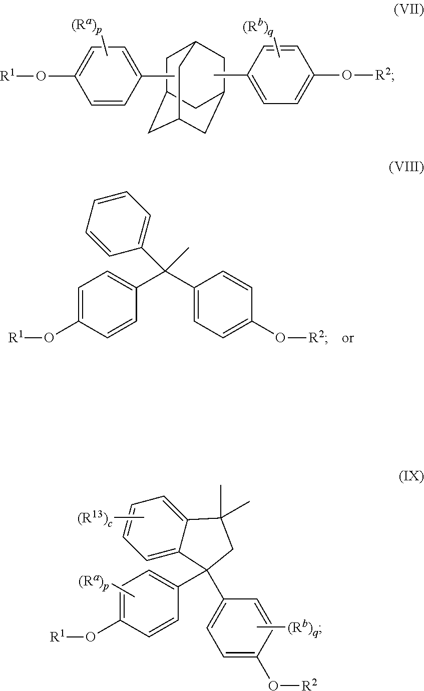

wherein R¹ and R² at each occurrence are each independently epoxide-containing functional group; R^{a} and R^{b} at each occurrence are each independently halogen, C₁-C₁₂ alkyl, C₂-C₁₂ alkenyl, C₃-C₈ cycloalkyl, or C₁-C₁₂ alkoxy; p and q at each occurrence are each independently 0 to 4; R¹³ at each occurrence is independently a halogen or a C₁-C₆ alkyl group; c at each occurrence is independently 0 to 4; R¹⁴ at each occurrence is independently a C₁-C₆ alkyl, phenyl, or phenyl substituted with up to five halogens or C₁-C₆ alkyl groups; R^{g} at each occurrence is independently C₁-C₁₂ alkyl or halogen, or two R^{g} groups together with the carbon atoms to which they are attached form a four-, five, or six-membered cycloalkyl group; and t is 0 to 10; a hardener; and optionally a solvent, to form the high heat epoxy prepreg, wherein the prepreg comprises 40 to 80 wt %, preferably 50 to 70 wt % substrate, 20 to 60 wt % matrix composition, preferably 50 to 30 wt % matrix composition, wherein the prepreg comprises 15 to 50 wt % of the compound having formula (I) to (IX), a cured, laminated sample of the prepreg has a flexural strength of greater than 850 MPa measured as per ASTM D7264; and a flexural modulus of greater than 65 GPa measured as per ASTM D7264, a cured sample of the matrix composition has a glass transition temperature of greater than or equal to 200° C. is provided.

A prepreg formed by a provided method is provided. A high heat epoxy composite produced by consolidating a prepreg formed by a provided method is provided. An article comprising a provided composite is provided.

The above described and other features are exemplified by the following detailed description.

### DETAILED DESCRIPTION

The inventors hereof have discovered compositions that provide desirable properties in composite materials.

The high heat epoxy composite comprises a substrate; and a matrix composition comprising a high heat epoxy compound and a hardener. In an embodiment, the hardener is an aromatic diamine compound. The matrix composition comprises 20 to 40 total weight percent of the composite. A cured sample of the matrix composition has a glass transition temperature of greater than or equal to 200° C.; and a cured, laminated sample of the composite has a flexural strength of greater than 850 MPa measured as per ASTM D7264; and a flexural modulus of greater than 65 GPa measured as per ASTM D7264.

The substrate can be any suitable material that can be coated with the matrix composition. The substrate can include organic or inorganic materials such as wood, cellulose, metal, glass, carbon (e.g., pyrolyzed carbon, graphite, graphene, nanofibers, or nanotubes), polymer, or ceramic. A combination of different materials can be used. In an embodiment, an electrically conductive material, e.g., a metal such as copper or aluminum, or an alloy thereof, can be used. In some embodiments a fibrous substrate is used. The fiber can be inorganic fiber, for example ceramic fiber, boron fiber, silica fiber, alumina fiber, zirconia fiber, basalt fiber, metal fiber, or glass fiber; or organic fiber, for example a carbon fiber or polymer fiber. The fibers can be coated with a layer of conductive material to facilitate conductivity. The fibers can be monofilament or multifilament fibers and can be used individually or in combination with other types of fiber, through, for example, co-weaving or core/sheath, side-by-side, orange-type or matrix and fibril constructions, or by other methods known to one skilled in the art of fiber manufacture. The fibrous substrate can be a woven or co-woven fabric (such as 0 to 90 degree fabrics or the like), a non-woven fabric (such as a continuous strand mat, chopped strand mat, tissues, papers, felts, or the like), plain weave cloth, satin weave cloth, non-crimp fabric, unidirectional fibers, braids, tows, ends, roving, rope, or a combination including at least one of the foregoing. Co-woven structures include glass fiber-carbon fiber, carbon fiber-aromatic polyimide (aramid) fiber, and aromatic polyimide fiberglass fiber. In some embodiments the substrate can include a glass fiber, a carbon fiber, or a combination including at least one of the foregoing. The substrate can be a carbon fiber tow. A carbon fiber tow can include any number of individual carbon fiber filaments, such as 6,000, 12,000, 18,000, 24,000, 60,000, or 80,000.

In embodiments, the substrate can be a high modulus carbon-fiber, intermediate modulus carbon-fiber, high strength carbon-fiber, E-glass, S-glass, aramid fiber, or a combination comprising at least one of the foregoing.

In an embodiment, the matrix composition comprises a high heat epoxy compound and an aromatic diamine compound. In an embodiment, the matrix composition comprises 50 to 85 weight percent of the high heat epoxy compound and 15 to 50 weight percent of the aromatic diamine compound. In an embodiment, the matrix composition comprises 75 to 85 weight percent of the high heat epoxy compound and 15 to 25 weight percent of the aromatic diamine compound.

The high heat epoxy compound can have formula (I) to (IX):

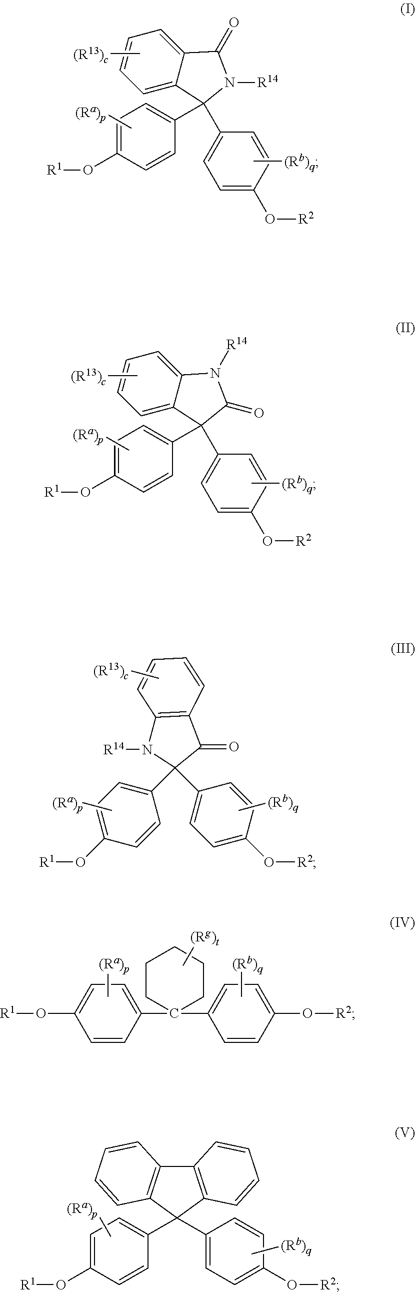

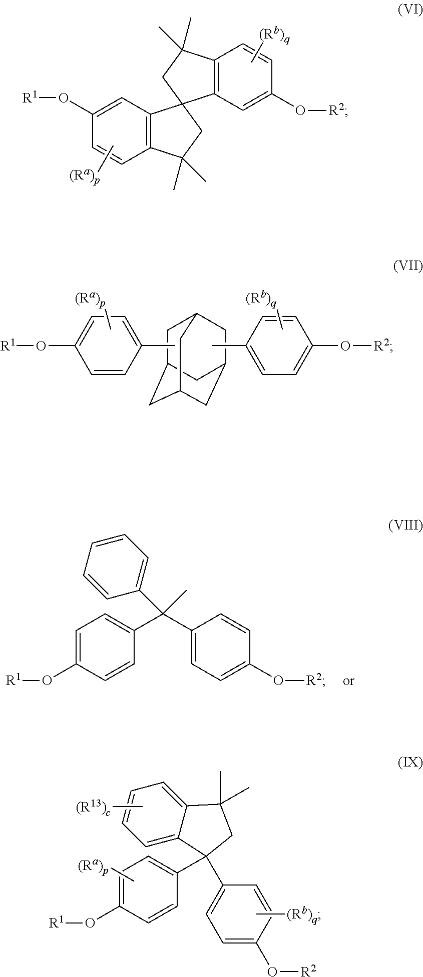

wherein R¹ and R² at each occurrence are each independently an epoxide-containing functional group; R^{a} and R^{b} at each occurrence are each independently halogen, C₁-C₁₂ alkyl, C₂-C₁₂ alkenyl, C₃-C₈ cycloalkyl, or C₁-C₁₂ alkoxy; p and q at each occurrence are each independently 0 to 4; R¹³ at each occurrence is independently a halogen or a C₁-C₆ alkyl group; c at each occurrence is independently 0 to 4; R¹⁴ at each occurrence is independently a C₁-C₆ alkyl, phenyl, or phenyl substituted with up to five halogens or C₁-C₆ alkyl groups; R^{g} at each occurrence is independently C₁-C₁₂ alkyl or halogen, or two R^{g} groups together with the carbon atoms to which they are attached form a four-, five, or six-membered cycloalkyl group; and t is 0 to 10.

In embodiments, R¹ and R² at each occurrence can each be independently:

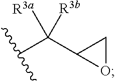

wherein R^{3a} and R^{3b} are independently hydrogen or C₁-C₁₂ alkyl. In certain embodiments, R¹ and R² are each independently

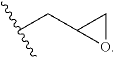 [SMILES: *CC1CO1]

In embodiments, the high heat epoxy compound can have the formula

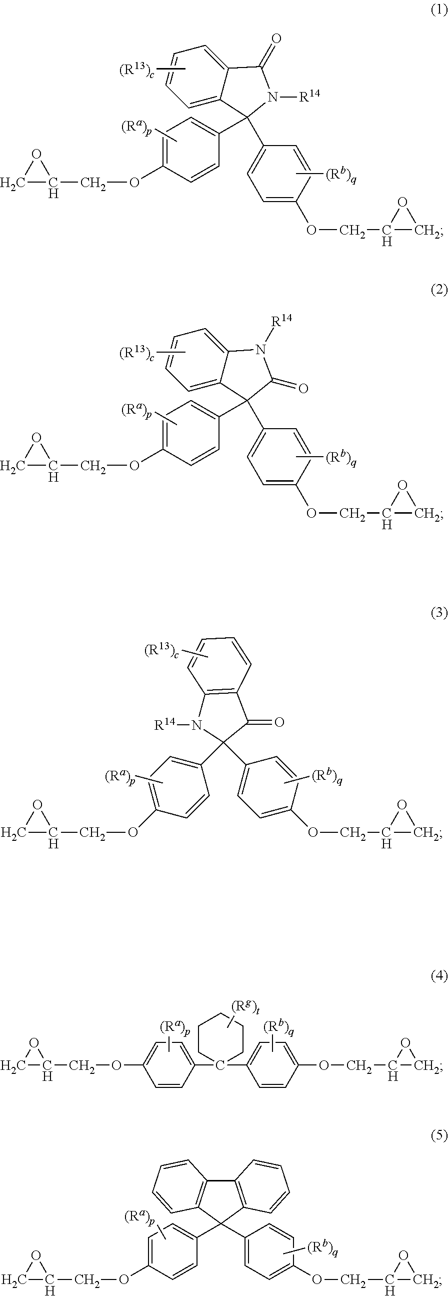

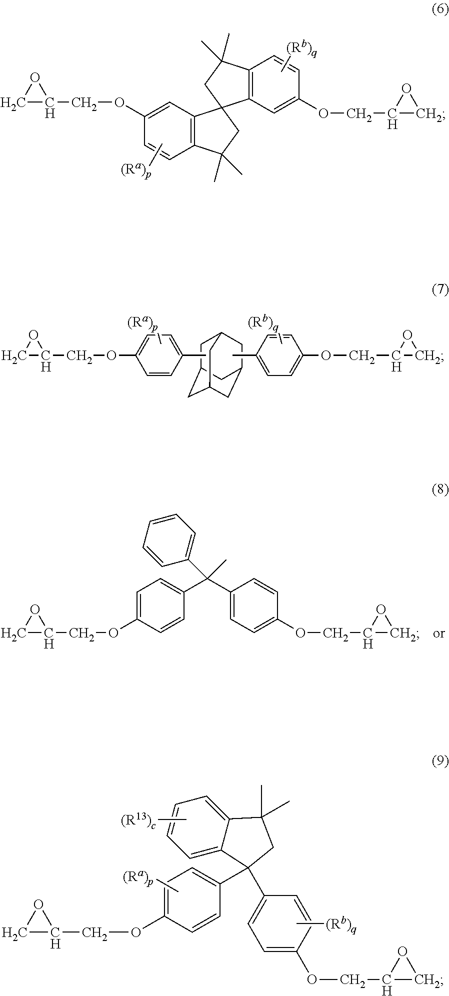

wherein R^{a} and R^{b} at each occurrence are each independently halogen, C₁-C₁₂ alkyl, C₂-C₁₂ alkenyl, C₃-C₈ cycloalkyl, or C₁-C₁₂ alkoxy; p and q at each occurrence are each independently 0 to 4; R¹³ at each occurrence is independently a halogen or a C₁-C₆ alkyl group; c at each occurrence is independently 0 to 4; R¹⁴ at each occurrence is independently a C₁-C₆ alkyl, phenyl, or phenyl substituted with up to five halogens or C₁-C₆ alkyl groups; R^{g} at each occurrence is independently C₁-C₁₂ alkyl or halogen, or two R^{g} groups together with the carbon atoms to which they are attached form a four-, five, or six-membered cycloalkyl group; and t is 0 to 10.

In some embodiments, R^{a} and R^{b} at each occurrence are each independently halogen, C₁-C₁₂ alkyl, or C₁-C₁₂ alkoxy; p and q at each occurrence are each independently 0 to 2; R¹³ at each occurrence is independently a halogen or a C₁-C₃ alkyl group; c at each occurrence is independently 0 to 2; R¹⁴ at each occurrence is independently a C₁-C₆ alkyl or phenyl; R^{g} at each occurrence is independently C₁-C₁₂ alkyl, or two R^{g} groups together with the carbon atoms to which they are attached form a four-, five, or six-membered cycloalkyl group; and t is 1 to 5.

In some embodiments, R^{a} and R^{b} at each occurrence are each independently C₁-C₆ alkyl, or C₁-C₆ alkoxy; p and q at each occurrence are each independently 0 to 2; R′³ at each occurrence is independently a C₁-C₃ alkyl group; c at each occurrence is independently 0 to 2; R¹⁴ at each occurrence is independently a C₁-C₃ alkyl or phenyl; R^{g} at each occurrence is independently C₁-C₆ alkyl; and t is 1 to 5.

In embodiments, the high heat epoxy compound can have the formula (1-a), (2-a), or (4-b)

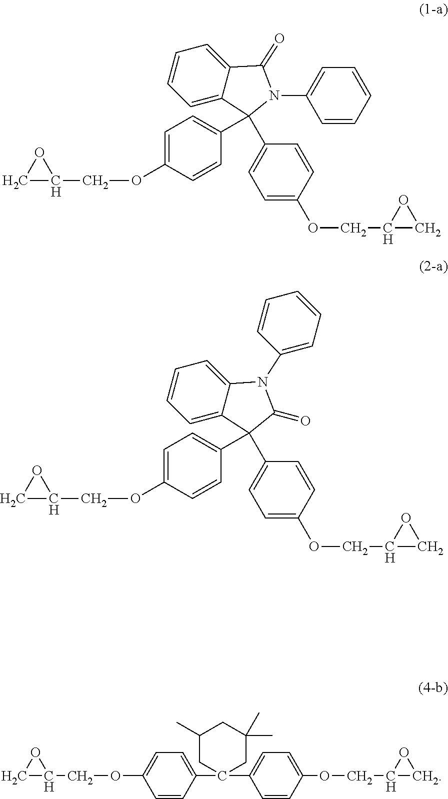 [SMILES: O=C1c2ccccc2C(c2ccc(OCC3CO3)cc2)(c2ccc(OCC3CO3)cc2)N1c1ccccc1 ; O=C1N(c2ccccc2)c2ccccc2C1(c1ccc(OCC2CO2)cc1)c1ccc(OCC2CO2)cc1 ; CC1CC(C)(C)CC(c2ccc(OCC3CO3)cc2)(c2ccc(OCC3CO3)cc2)C1]

In an embodiment, the high heat epoxy compound has the formula (1-a)

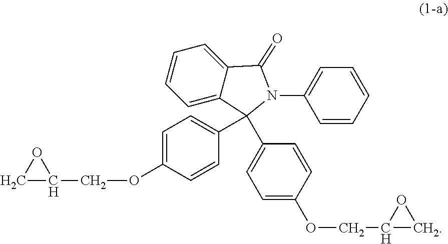 [SMILES: O=C1c2ccccc2C(c2ccc(OCC3CO3)cc2)(c2ccc(OCC3CO3)cc2)N1c1ccccc1]

The high heat epoxy compound can be prepared by methods described in, for example, WO2016/014536. The high heat epoxy compound can be from a corresponding bisphenol compound [e.g., a bisphenol of formula (1′) to (9′)].

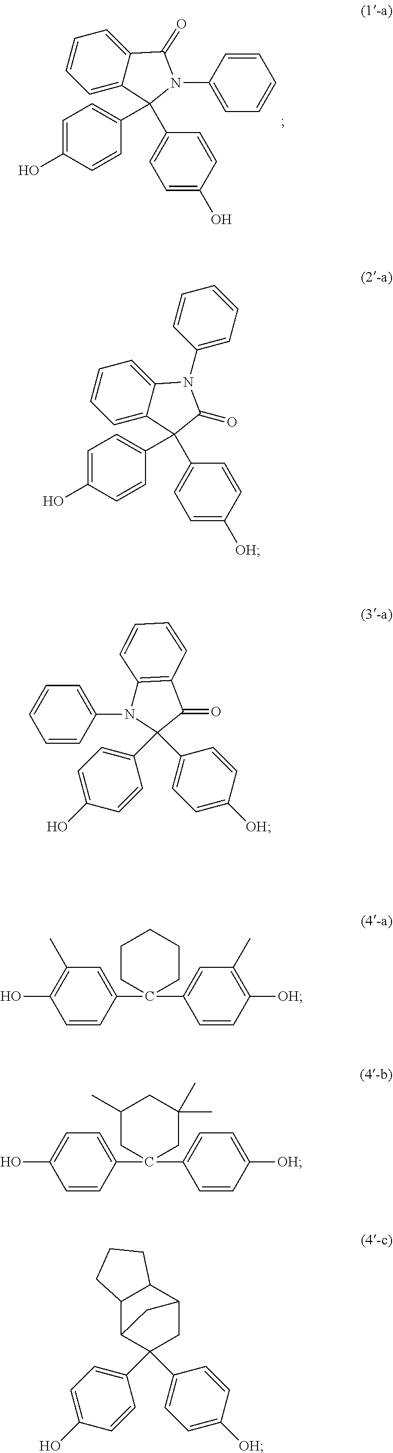

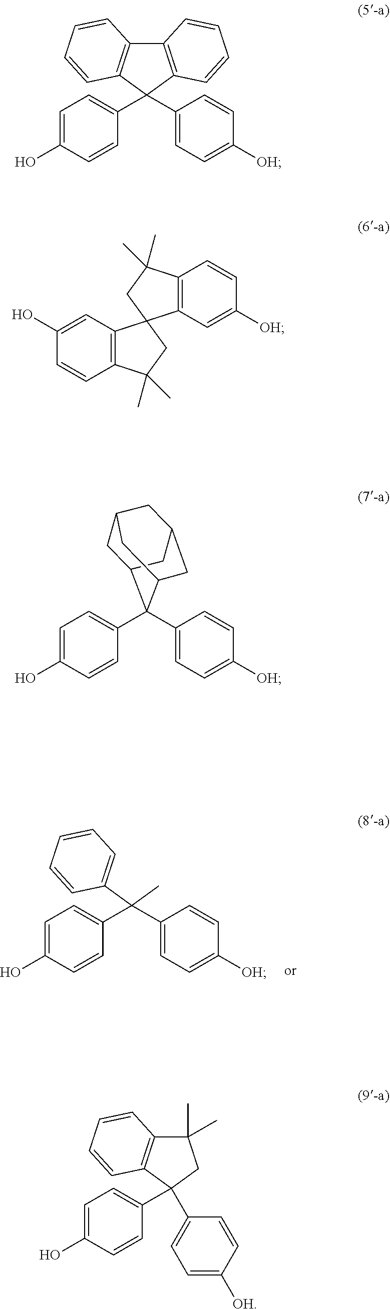 [SMILES: Oc1ccc(C2(c3ccc(O)cc3)c3ccccc3-c3ccccc32)cc1 ; CC1(C)CC2(CC(C)(C)c3ccc(O)cc32)c2cc(O)ccc21 ; Oc1ccc(C2(c3ccc(O)cc3)C3CC4CC(C3)CC2C4)cc1 ; CC(c1ccccc1)(c1ccc(O)cc1)c1ccc(O)cc1 ; "or" ; CC1(C)CC(c2ccc(O)cc2)(c2ccc(O)cc2)c2ccccc21]

The bisphenol can be provided in a mixture with an epoxide source, such as epichlorohydrin. The resultant mixture can be treated with a catalytic amount of base at a selected temperature. Suitable bases include, but are not limited to, carbonates (e.g., sodium bicarbonate, ammonium carbonate, or dissolved carbon dioxide), and hydroxide bases (e.g., sodium hydroxide, potassium hydroxide, or ammonium hydroxide). The base can be added as a powder (e.g., powdered sodium hydroxide). The base can be added slowly (e.g., over a time period of 60 to 90 minutes). The temperature of the reaction mixture can be maintained at 20° C. to 24° C., for example. The reaction can be stirred for a selected time period (e.g., 5 hours to 24 hours, or 8 hours to 12 hours). The reaction can be quenched by addition of an aqueous solvent, optionally along with one or more organic solvents (e.g., ethyl acetate). The aqueous layer can be extracted (e.g., with ethyl acetate), and the organic extract can be dried and concentrated. The crude product can be purified (e.g., by silica gel chromatography) and isolated. The isolated product can be obtained in a yield of 80% or greater, 85% or greater, or 90% or greater.

In certain embodiments, the composition may comprise high heat epoxy compound wherein the purity is 95% or greater, preferably 97% or greater, preferably 99% or greater, as determined by high performance liquid chromatography (HPLC). WO 2016/014536A1 and US Publication 2015/041338 disclose that high purity epoxy with low oligomer content exhibits lower viscosity, which can facilitates fiber wet out during processing to make prepregs and laminates.

The high heat epoxy compound can have a metal impurity content of 3 ppm or less, 2 ppm or less, 1 ppm or less, 500 ppb or less, 400 ppb or less, 300 ppb or less, 200 ppb or less, or 100 ppb or less. The metal impurities may be iron, calcium, zinc, aluminum, or a combination thereof. The compounds can have an unknown impurities content of 0.1 wt % or less. The compounds can have a color APHA value of 40 or less, 35 or less, 30 or less, 25 or less, 20 or less, 19 or less, 18 or less, 17 or less, 16 or less, or 15 or less, as measured using test method ASTM D1209.

The high heat epoxy compounds can be substantially free of epoxide oligomer impurities. The epoxides can have an oligomer impurity content of less than or equal to 3%, less than or equal to 2%, less than or equal to 1%, less than or equal to 0.5%, less than or equal to 0.4%, less than or equal to 0.3%, less than or equal to 0.2%, or less than or equal to 0.1%, as determined by high performance liquid chromatography. The epoxides can have an epoxy equivalent weight corresponding to purity of the bisepoxide of 95% purity or greater, 96% purity or greater, 97% purity or greater, 98% purity or greater, 99% purity or greater, or 100% purity. Epoxy equivalent weight (EEW) is the weight of material in grams that contains one mole of epoxy groups. It is also the molecular weight of the compound divided by the number of epoxy groups in one molecule of the compound.

The matrix composition comprises 20 to 60 total weight percent of the composite. In an embodiment, the matrix composition comprises 30 to 50 total weight percent of the composite. In an embodiment, the matrix composition comprises 20 to 40 total weight percent of the composite.

The matrix composition can include a curing promoter. The term “curing promoter” as used herein encompasses compounds whose roles in curing epoxy compounds are variously described as those of a hardener, a hardening accelerator, a curing catalyst, and a curing co-catalyst, among others. The curing promoter can be a hardener. The hardener can be an aromatic diamine compound.

The amount of curing promoter will depend on the type of curing promoter, as well as the identities and amounts of the other components of the matrix composition. For example, in an embodiment, when the curing promoter is an aromatic diamine compound, it can be used in an amount of 10 to 30 weight percent of the matrix composition.

In embodiments, the aromatic diamine compound can be 4-aminophenyl sulfone (DDS), 4,4′-methylenedianiline, diethyltoluenediamine, 4,4′-methylenebis(2,6-diethyl)-aniline, m-phenylenediamine, p-phenylenediamine, 2,4-bis(p-aminobenzyl)aniline, 3,5-diethyltoluene-2,4-diamine, 3,5-diethyltoluene-2,6-diamine, m-xylylenediamine, p-xylylenediamine, diethyl toluene diamines, or a combination comprising at least one of the foregoing.

The hardener can be an aromatic dianhydride. In embodiments, the aromatic dianhydride compound has the general structure

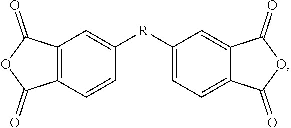

where R can be a single bond,

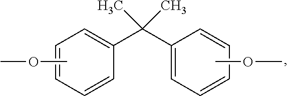

other bisphenols, —C(CF3)2-, —O—, or —C(═O)—.

Other examples of hardeners include 4,4′-(4,4′-isopropylidenediphenoxy)bis-(phthalic anhydride) (CAS Reg. No. 38103-06-9), 4,4′-(hexafluoroisopropylidene)diphthalic anhydride (CAS Reg. No. 1107-00-2), 4,4′-oxydiphthalic anhydride (CAS Reg. No. 1823-59-2), benzophenone-3,3′,4,4′-tetracarboxylic dianhydride (CAS Reg. No. 2421-28-5), and 3,3′,4,4′-biphenyltetracarboxylic dianhydride (CAS Reg. No. 2420-87-3), and specifically compounds having the formulas below.

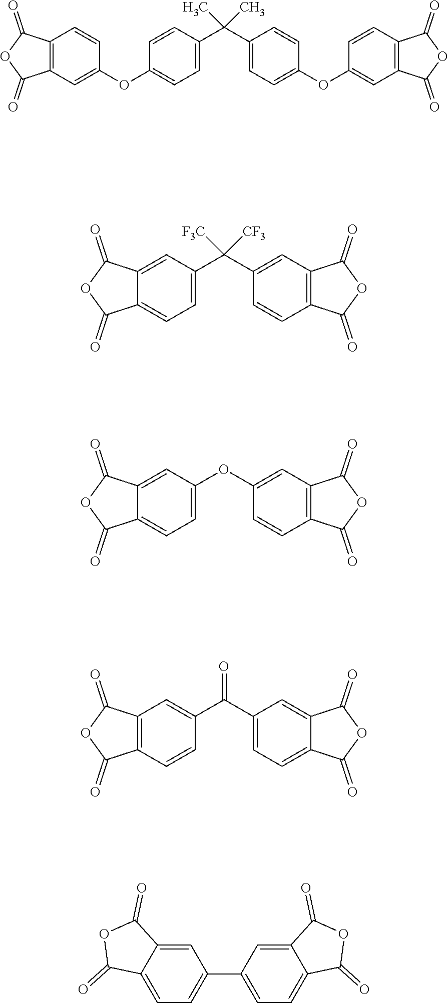 [SMILES: CC(C)(c1ccc(Oc2ccc3c(c2)C(=O)OC3=O)cc1)c1ccc(Oc2ccc3c(c2)C(=O)OC3=O)cc1 ; O=C1OC(=O)c2cc(C(c3ccc4c(c3)C(=O)OC4=O)(C(F)(F)F)C(F)(F)F)ccc21 ; O=C1OC(=O)c2cc(Oc3ccc4c(c3)C(=O)OC4=O)ccc21 ; O=C(c1ccc2c(c1)C(=O)OC2=O)c1ccc2c(c1)C(=O)OC2=O ; O=C1OC(=O)c2cc(-c3ccc4c(c3)C(=O)OC4=O)ccc21]

The hardener can be a bicyclic anhydride. In embodiments, the bicyclic anhydride compound can be methyl-5-norbornene-2,3-dicarboxylic anhydride (CAS Reg. No. 25134-21-8) and cis-5-norbornene-endo-2,3-dicarboxylic anhydride (CAS Reg. No. 129-64-6) and specifically compounds having the formulas below.

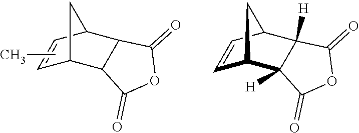

Also provided is a method of manufacturing a high heat epoxy prepreg, comprising coating a substrate with a matrix composition. Coating the substrate with the matrix composition can be by any suitable method, including immersing the substrate into the matrix composition, for a suitable time, in an embodiment, for up to 30 minutes, in an embodiment, for up to 15 minutes; spraying the matrix composition onto the substrate; curtain coating the substrate with the matrix composition, pouring the matrix composition onto the substrate; or a combination comprising at least one of the foregoing.

Heating the coated substrate to form a prepreg can include heating at a temperature from 25 to 100° C. for 1 to 10 hours.

The prepreg can be prepared in any form, where the form is generally dictated by the shape of the substrate. For example, a fabric or a fiber tow can provide a layer of substrate. Where a fiber tow comprising continuous, unidirectional fibers is pre-impregnated, the prepreg is generally referred as a unidirectional tape. The thickness of such layers or tapes can vary widely, for example from 5 micrometers to 1 millimeters (mm).

Composites can be prepared by consolidation of the prepregs by methods known in art. For example, laminates can be prepared by contacting at least two layers of a prepreg under conditions of heat and pressure sufficient to consolidate the prepreg. Effective temperatures can include 100 to 300° C., at pressures from 20 to 2000 pounds per square inch (PSI), for example. A laminate can include at least two layers of the prepreg, particularly the prepreg. In an embodiment, a laminate includes from two to one hundred layers of the prepreg, particularly the prepreg. In some embodiments, all of the layers of the laminate are formed from the prepreg, in particular the prepreg. In other embodiments, the laminate can comprise other layers, for example a different prepreg. In some embodiments, all of the prepreg layers used to form the laminate are the prepregs produced as described herein.

In some embodiments, a non-prepreg layer can be present such as a release layer, a copper foil, or an adhesive to enhance bonding between two layers. The adhesive can be applied using any suitable method, for example, spreading, spraying, and dipping. The adhesive can be any adhesive that provides the desired adhesion between layer(s) of the prepregs or tapes. An adhesive can be polyvinylbutyral (PVB), ethylene-vinyl acetate copolymer (EVA), an epoxy, an ultraviolet (UV) or water-curable adhesive such as a cyanoacrylate or other acrylic, or a combination comprising at least one or the foregoing.

In some embodiments the composite, in particular the laminate, can be thermoformed, for example, vacuum thermoformed, to form a shape.

The matrix compositions can be used in electronic applications such as encapsulants, adhesives, polymer coated copper, prepregs, and printed circuit boards. In addition, the matrix compositions can be used in structural composites, industrial adhesives, and coatings. Methods of forming composites for use in printed circuit boards are known in the art and are described in, for example, U.S. Pat. No. 5,622,588 to Weber, U.S. Pat. No. 5,582,872 to Prinz, and U.S. Pat. No. 7,655,278 to Braidwood.

Additional applications for the matrix compositions and composites include, for example, acid bath containers; neutralization tanks; aircraft components; bridge beams; bridge deckings; electrolytic cells; exhaust stacks; scrubbers; sporting equipment; stair cases; walkways; automobile exterior panels such as hoods and trunk lids; floor pans; air scoops; pipes and ducts, including heater ducts; industrial fans, fan housings, and blowers; industrial mixers; boat hulls and decks; marine terminal fenders; tiles and coatings; building panels; business machine housings; trays, including cable trays; concrete modifiers; dishwasher and refrigerator parts; electrical encapsulants; electrical panels; tanks, including electrorefining tanks, water softener tanks, fuel tanks, and various filament-wound tanks and tank linings; furniture; garage doors; gratings; protective body gear; luggage; outdoor motor vehicles; pressure tanks; printed circuit boards; optical waveguides; radomes; railings; railroad parts such as tank cars; hopper car covers; car doors; truck bed liners; satellite dishes; signs; solar energy panels; telephone switchgear housings; tractor parts; transformer covers; truck parts such as fenders, hoods, bodies, cabs, and beds; insulation for rotating machines including ground insulation, turn insulation, and phase separation insulation; commutators; core insulation and cords and lacing tape; drive shaft couplings; propeller blades; missile components; rocket motor cases; wing sections; sucker rods; fuselage sections; wing skins and flarings; engine narcelles; cargo doors; tennis racquets; golf club shafts; fishing rods; skis and ski poles; bicycle parts; transverse leaf springs; pumps, such as automotive smog pumps; electrical components, embedding, and tooling, such as electrical cable joints; wire windings and densely packed multi-element assemblies; sealing of electromechanical devices; battery cases; resistors; fuses and thermal cut-off devices; coatings for printed wiring boards; casting items such as capacitors, transformers, crankcase heaters; small molded electronic parts including coils, capacitors, resistors, and semiconductors; as a replacement for steel in chemical processing, pulp and paper, power generation, and wastewater treatment; scrubbing towers; pultruded parts for structural applications, including structural members, gratings, and safety rails; swimming pools, swimming pool slides, hot-tubs, and saunas; drive shafts for under the hood applications; dry toners for copying machines; marine tooling and composites; heat shields; submarine hulls; prototype generation; development of experimental models; laminated trim; drilling fixtures; bonding jigs; inspection fixtures; industrial metal forming dies; aircraft stretch block and hammer forms; vacuum molding tools; flooring, including flooring for production and assembly areas, clean rooms, machine shops, control rooms, laboratories, parking garages, freezers, coolers, and outdoor loading docks; electrically conductive compositions for antistatic applications; for decorative flooring; expansion joints for bridges; injectable mortars for patch and repair of cracks in structural concrete; grouting for tile; machinery rails; metal dowels; bolts and posts; repair of oil and fuel storage tanks, and numerous other applications.

Methods of forming a composite can include impregnating a reinforcing substrate with the matrix composition; partially curing the matrix composition to form a prepreg; and laminating a plurality of prepregs; wherein the matrix composition comprises a high heat epoxy compound, a hardener, and optionally, one or more additional additives.

Reinforcing substrates suitable for prepreg formation are known in the art. Suitable reinforcing substrates include reinforcing fabrics. Reinforcing fabrics include those having complex architectures, including two or three-dimensional braided, knitted, woven, and filament wound. The matrix composition is capable of permeating such complex reinforcing substrates. The reinforcing substrate can comprise fibers of materials known for the reinforcement of plastics material, for example fibers of carbon, glass, metal, and aromatic polyamides. Suitable reinforcing substrates are described, for example, in Anonymous (Hexcel Corporation), “Prepreg Technology”, March 2005, Publication No. FGU 017b; Anonymous (Hexcel Corporation), “Advanced Fibre Reinforced Matrix Products for Direct Processes”, June 2005, Publication No. ITA 272; and Bob Griffiths, “Farnborough Airshow Report 2006”, CompositesWorld.com, September 2006. The weight and thickness of the reinforcing substrate are chosen according to the intended use of the composite using criteria well known to those skilled in the production of fiber reinforced polymer composites. The reinforced substrate can contain various finishes suitable for the matrix composition.

The method of forming the composite comprises partially curing the matrix composition after the reinforcing substrate has been impregnated with it. Partial curing is curing sufficient to reduce or eliminate the wetness and tackiness of the matrix composition but not so great as to fully cure the composition. The polymer in a prepreg is customarily in the partially cured state, and those skilled in the thermoset arts, and particularly the reinforced composite arts, understand the concept of partial curing and how to determine conditions to partially cure a polymer without undue experimentation. References herein to properties of the “cured composition” refer to a composition that is substantially fully cured. For example, the polymer in a laminate formed from prepregs is typically substantially fully cured. One skilled in the thermoset arts can determine whether a sample is partially cured or substantially fully cured without undue experimentation. For example, one can analyze a sample by differential scanning calorimetry to look for an exotherm indicative of additional curing occurring during the analysis. A sample that is partially cured will exhibit an exotherm. A sample that is substantially fully cured will exhibit little or no exotherm. Partial curing can be effected by subjecting the matrix-composition-impregnated reinforcing substrate to a temperature of 133 to 140° C. for 4 to 10 minutes.

Commercial-scale methods of forming composites are known in the art, and the matrix compositions described herein are readily adaptable to existing processes and equipment. For example, prepregs are often produced on treaters. The main components of a treater include feeder rollers, an impregnation tank, a treater oven, and receiver rollers. The reinforcing substrate (E-glass, for example) is usually rolled into a large spool. The spool is then put on the feeder rollers that turn and slowly roll out the reinforcing substrate. The reinforcing substrate then moves through the polymer impregnation tank, which contains the matrix composition. The varnish impregnates the reinforcing substrate. After emerging from the tank, the coated reinforcing substrate moves upward through the vertical treater oven, which is typically at a temperature of 175 to 200° C., and the solvent of the varnish is boiled away. The matrix begins to polymerize at this time. When the composite comes out of the tower it is sufficiently cured so that the web is not wet or tacky. The cure process, however, is stopped short of completion so that additional curing can occur when laminate is made. The web then rolls the prepreg onto a receiver roll.

While the above-described curing methods rely on thermal curing, it is also possible to effect curing with radiation, including ultraviolet light and electron beams. Combinations of thermal curing and radiation curing can also be used.

In certain embodiments, a composite is formed by a method comprising impregnating a reinforcing substrate with a matrix composition; partially curing the matrix composition to form a prepreg; and laminating a plurality of prepregs; wherein the matrix composition comprises a high heat epoxy compound, a hardener, and optionally, one or more additional additives. In an embodiment, the hardener is an aromatic diamine compound.

In certain embodiments, a printed circuit board comprises a composite formed by a method comprising impregnating a reinforcing substrate with a matrix composition; partially curing the matrix composition to form a prepreg; and laminating a plurality of prepregs; wherein the matrix composition comprises a high heat epoxy compound, a hardener, and optionally, one or more additional additives. In an embodiment, the hardener is an aromatic diamine compound.

Processes useful for preparing the articles and materials include those generally known to the art for the processing of thermosetting polymers. Such processes have been described in the literature as in, for example, Engineered Materials Handbook, Volume 1, Composites, ASM International Metals Park, Ohio, copyright 1987 Cyril A. Distal Senior Ed, pp. 105-168 and 497-533, and “Polyesters and Their Applications” by Bjorksten Research Laboratories, Johan Bjorksten (pres.) Henry Tovey (Ch. Lit. Ass.), Betty Harker (Ad. Ass.), James Henning (Ad. Ass.), Reinhold Publishing Corporation, New York, 1956. Processing techniques include polymer transfer molding; sheet molding; bulk molding; pultrusion; injection molding, including reaction injection molding (RIM); atmospheric pressure molding (APM); casting, including centrifugal and static casting open mold casting; lamination including wet or dry layup and spray lay up; also included are contact molding, including cylindrical contact molding; compression molding; including vacuum assisted polymer transfer molding and chemically assisted polymer transfer molding; matched tool molding; autoclave curing; thermal curing in air; vacuum bagging; pultrusion; Seeman's Composite Resin Infusion Manufacturing Processing (SCRIMP); open molding, continuous combination of polymer and glass; and filament winding, including cylindrical filament winding. In certain embodiments, an article can be prepared from the disclosed matrix compositions via a polymer transfer molding process.

In another aspect, disclosed is a material comprising the composite. The material can be a coating, an adhesive, a composite, an encapsulant, a sealant, or a combination thereof. The composite can be a glass fiber composite, a carbon fiber composite, or a combination thereof. The material can be produced by a polymer transfer molding process.

In another aspect, disclosed is an article comprising the composite. The article can be electrical components, computer components, printed circuit boards, and automotive, aircraft, and watercraft exterior or interior components. The article can be produced by a polymer transfer molding process.

The matrix composition optionally comprises a solvent. In an embodiment, the solvent is present 10 and 26 wt % of the total solution. In an embodiment, the solvent is dioxane and provides a stable homogeneous liquid blend at ambient temperatures.

In an embodiment, a prepreg comprises 40 to 80 wt % substrate (32 to 74 volume %), and 20 to 60 wt % matrix composition (26 to 68 volume %), wherein the matrix composition comprises 15 to 50 wt % (22 to 57 volume %) high heat epoxy compound.

The compositions and methods described herein are further illustrated by the following non-limiting examples.

### EXAMPLES

The following components are used in the examples. Unless specifically indicated otherwise, the amount of each component is in weight percent in the following examples, based on the total weight of the composition.

TABLE 1

| Component | Description | Source |
|---|---|---|
| TGDDM | Tetraglycidyldiaminodiphenylmethane, CAS Reg. No. | Huntsman |
| | 28768-32-3; with an epoxy equivalent weight of 113 | Advanced |
| | grams/equivalent; obtained as ARALDITE MY 721 | Materials |
| PPPBP-epoxy | 1,1-bis(4-epoxyphenyl)-N-phenylphthalimidine, with | SABIC |
| | an epoxy equivalent weight 252.5 grams/equivalent | |
| DDS | 4-aminophenyl sulfone, CAS Reg. No. 80-08-0 | Sigma-Aldrich |
| Dioxane | 1,4-dioxane, CAS Reg. No. 123-91-1 | Sigma-Aldrich |
| Carbon-fiber | carbon fiber cloth HEXTOW IM7 PW (plain weave); | Hexcel |
| cloth | density of 1.78 g/cm³ | |

Compositions were tested using the test methods listed in Table 2. Unless indicated otherwise, all test methods are the test methods in effect as of the filing date of this application.

TABLE 2

| Property | Units | Description (Conditions) | Test | Specimen |
|---|---|---|---|---|
| Glass transition | ° C. | TA Instruments | ASTM D3418 | |
| temperature (T_{g}) | | 2920 M-DS. Scan | | |
| | | range from 30 to | | |
| | | 275° C. under a | | |
| | | nitrogen atmosphere | | |
| | | with a heating | | |
| | | rate of 20° C./min. | | |
| FS (flexural | MPa | Three-point loading | ASTM D7264 | |
| strength) | | fixture (6.35 cm span) | | |
| FM (flexural | GPa | Three-point loading | ASTM D7264 | |
| modulus) | | fixture (6.35 cm span) | | |
| Un-notched | J/m | Hammer energy of | ASTM D 4812 06 | Reported values |
| Izod | | 2 ft-lbs. Reported | | reflect and |
| impact | | values reflect | | average of 5 |
| strength | | an average of 5 test | | specimens per |
| | | specimens per | | composition. |
| | | composition. 23° C. | | |
| Fracture | MPa- | 23° C. | ASTM D5045 | |
| toughness, | m^{0.5} | | | |
| KIC | | | | |
| Fracture | J/m² | 23° C. | ASTM D5045 | |
| toughness, | | | | |
| GIC | | | | |
| Density | g/cc | | ASTM D792 | |
| Viscosity | cP | Brookfield digital spindle | Brookfield | Samples were placed |
| | | viscometer, Model DV-II, | viscometer | in the disposable |
| | | equipped with a Thermosel | Manufacturing | Spindle/Chambers |
| | | System for elevated | Operation Manual | assembly and the |
| | | temperature testing | No: m/85-160-G | temperature was |
| | | | | adjusted to the |
| | | | | test temperature. |
| | | | | After equilibration |
| | | | | for 5 minutes at the |
| | | | | test temperature, |
| | | | | the viscosity |
| | | | | was determined. |
| Percent | % | Percent shrinkage = | | |
| shrinkage | | 100*[(width mold − width | | |
| | | casting)/(width mold)] | | |

A comparison of the sensitivity to moisture was studied. All samples were dried in a vacuum oven for 16 hours at 120° C. and 640 mm Hg vacuum. After the dried samples were weighed and the length measured, they were placed in deionized water at 80° C. The samples were removed at certain time intervals, the surface moisture was wiped off, the samples were allowed to cool to ambient temperature, the samples were weighed and measured, and then the samples were returned to the water. After 200 hours the change in sample weight and length started to plateau. Values after 300 hours was chosen as the saturation point. The samples were removed from the water, the surface moisture was wiped off, allowed to cool to ambient temperature, and the final weight and length determined. The H₂O uptake was calculated using the following equation:

$${H}_{2} O uptake at Saturation , \% = \frac{[ Final weight - Initial weight ]}{Initial weight} \times 100$$

The H₂O growth was calculated using the following equation:

$${H}_{2} O growth at Saturation , \% = \frac{[ Final length - Initial length ]}{Initial length} \times 100$$

Shrinkage due to curing was measured on castings that were cured according to the schedule described. After the mold and casting were cooled to room temperature, the width of the mold was measured in 3 locations and the width of the casting was measured in the same 3 locations. The average mold width and the average casting width were used to calculate the shrinkage using the following equation:

$$Shrinkage , \% = \frac{[ Average mold width - Average casting width ]}{Average Mold width} \times 100$$

Cast parts were prepared using PPPBP-epoxy/DDS and TGDDM/DDS combinations where the compositions contained 15-17% excess epoxy equivalents. DDS was dissolved in the epoxy (either TGDDM or PPPBP-epoxy) by warming and stirring. The warm, homogeneous epoxy/DDS solution was degassed in a vacuum oven and then poured into a mold which was preheated to 120° C. The filled mold was placed in an oven at 120° C. and the cure temperature was programmed up to 220° C. Test parts were cut from the cast parts.

Test results from the cast parts are provided in Table 3.

TABLE 3

| | | | Test Method |
|---|---|---|---|
| PPPBP-Epoxy, wt % | 83.39 | — | |
| TGDDM, wt % | — | 68.6 | |
| DDS, wt % | 16.61 | 31.41 | |
| Tg, ° C. | 250 | 254 | ASTM D3418 |
| Un-notched Izod Impact | 71.8 | 58.4 | ASTM D 4812 06 |
| Strength, J/m | | | |
| Fracture toughness | | | ASTM D5045 |
| KIC, MPa-m^{0.5} | 0.50 | 0.41 | ASTM D5045 |
| GIC, J/m² | 149 | 101 | ASTM D5045 |
| H₂O uptake, Saturation, % | 4.14 | 5.71 | |
| H₂O growth, Saturation, % | 0.81 | 1.27 | |
| Shrinkage, % | 0.363 | 0.636 | |
| Density, g/cc | 1.2622 | 1.2845 | ASTM D 792 |

Both epoxy/DDS combinations exhibited similar high Tgs. However, the PPPBP-epoxy/DDS cast part had increased impact strength, higher fracture toughness, lower moisture absorbance, lower moisture growth, and lower density as compared to TGDDM/DDS. In addition, PPPBP-epoxy/DDS cast part had significantly less shrinkage after curing.

### PPPBP-Epoxy/DDS Composites

Evaluation of PPPBP-Epoxy/DDS in carbon-fiber composites is complicated by the solid nature of PPPBP-Epoxy/DDS below 65° C. In addition, the melt viscosity of PPPBP-Epoxy/DDS is too high for prepregging (862,000 cP at 70° C.). Therefore, a solvent was used as a processing aid.

A suitable solvent for both crystalline reactants, non-polar PPPBP-epoxy and polar DDS, should have a boiling point greater than ambient, but less than 120-140° C. (in order to avoid the temperature induced onset of rapid cure). Screening of solvent was done by warming the solvent to 70° C. and adding the PPPBP-epoxy/DDS. The concentration of solvent was varied. If the PPPBP-epoxy/DDS was soluble at 70° C., then the solution was cooled to ambient temperature and the solubility determined visually after 24 hours. Dioxane was selected as a suitable solvent.

Concentrations of dioxane less than 26 wt % were used to prepare homogeneous solutions of PPPBP-epoxy/DDS. At levels of dioxane greater than 27 wt %, the PPPBP-epoxy/DDS was not completely soluble at ambient temperatures.

Results of solubility testing of PPPBP-epoxy/DDS in dioxane are presented in Table 4.

TABLE 4

| | PPPBP- | | Solubility | Solubility |
|---|---|---|---|---|
| | Epoxy/ | Solubility | at 23° C. | at 23° C. |
| Dioxane, | DDS, | at | after | after |
| wt % | wt % | 70° C. | 24 hours | 170 hours |
| 50 | 50 | Soluble | Insoluble | — |
| 39.4 | 60.6 | Soluble | Insoluble | — |
| 35.5 | 64.5 | Soluble | Insoluble | — |
| 31.1 | 68.9 | Soluble | Insoluble | — |
| 28.6 | 71.4 | Soluble | Insoluble | — |
| 27.3 | 72.7 | Soluble | Insoluble | — |
| 25.8 | 74.2 | Soluble | Soluble | Soluble |
| 24 | 76 | Soluble | Soluble | Soluble |
| 22.3 | 77.7 | Soluble | Soluble | Soluble |
| 10 | 90 | Soluble | Soluble | Soluble |

The effect of the amount of dioxane and temperature on the viscosity appears in Table 5.

TABLE 5

| | Spindle viscosity, cP | | |
|---|---|---|---|
| Temperature, | 26 wt % | 24 wt % | 10 wt % |
| ° C. | dioxane | dioxane | dioxane |
| 100 | — | — | 5525 |
| 90 | — | 80 | 16400 |
| 80 | — | 148 | 73400 |
| 70 | — | 320 | 195000 |
| 60 | — | 755 | — |
| 50 | 1460 | 2,000 | — |
| 40 | 5227 | 5,600 | — |
| 30 | 23,675 | 26,050 | — |

It is seen that the viscosity increases as the temperature decreases. At a given temperature, the viscosity is lower with a higher amount of dioxane.

### Composite Materials

PPPBP-epoxy was dissolved in warm dioxane. The curing promoter DDS was dissolved in the solution. The weight percent (wt %) of PPPBP-epoxy and DDS were 82.151 and 17.849, respectively. The percent of solids was 77.7. The excess epoxy equivalents was 15%. The solution was stable and there was no indication of any precipitation after 20 days.

A comparative material was prepared by dissolving DDS in warm TGDDM. The wt % of TGDDM and DDS were 66.687 and 33.313, respectively. The excess epoxy equivalents was 15%.

The carbon fiber cloth used in both examples was HEXTOW IM7 PW (plain weave) from Hexcel.

Prepregs were prepared by impregnating the carbon fiber cloth with the polymer solutions. The carbon fiber cloth and carrier/release paper (on one roll) were pulled through heated rolls (heated to 70° C.). The polymer which was preheated to 70° C. was poured onto the cloth between the rolls. The paper/fiber/polymer was sandwiched with another carrier/release paper. The sandwiched prepreg was pulled through heated compaction rolls, and then led through cooling rolls. In the final stage of the process, one of the carrier papers was removed and the final prepreg was rolled with the one carrier paper.

Laminates were prepared by vacuum bag molding. 15 layers of prepreg were stacked in the mold and the temperature was increased from ambient temperature to 121° C. at 2.8° C./minute (min) under full vacuum and 60 pounds per square inch (PSI) pressure (or 0.414 megaPascal (MPa)). The temperature was held at 121° C. for 1 hour. The temperature was then increased from 121° C. to 185° C. at 2.8° C./min. The temperature was held at 185° C. for 4 hours. The laminate was cooled from 185° C. to ambient at 5.6° C./min. The pressure/vacuum was vented at ambient temperature. Laminates were cut into test parts and tested. Results are provided in Table 6.

TABLE 6

| | PPPBP- | | |
|---|---|---|---|
| | epoxy/ | TGDDM/ | |
| | DDS | DDS | Test Method |
| Carbon-fiber, wt % | 67.9 | 67.5 | ASTM D3171 |
| Flexural Strength, MPa | 884.6 | 849.8 | ASTM D7264 |
| Flexural Modulus, GPa | 74.6 | 61.0 | ASTM D7264 |
| Glass transition | 249 | 252 | ASTM D3418 |
| temperature, ° C. | | | |

The PPPBP-epoxy/DDS laminates have higher flexural strength and flexural modulus, as compared to the comparative TGDDM/DDS material.

The compositions, methods, articles and other aspects are further described by the Embodiments below.

### Embodiment 1

A high heat epoxy composite comprising: a substrate; a matrix composition comprising: a high heat epoxy compound having formula:

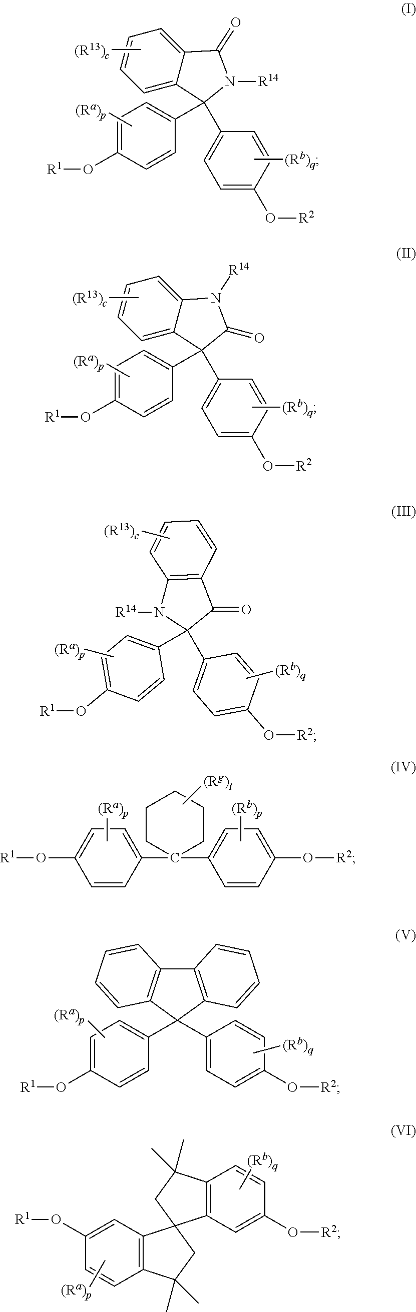

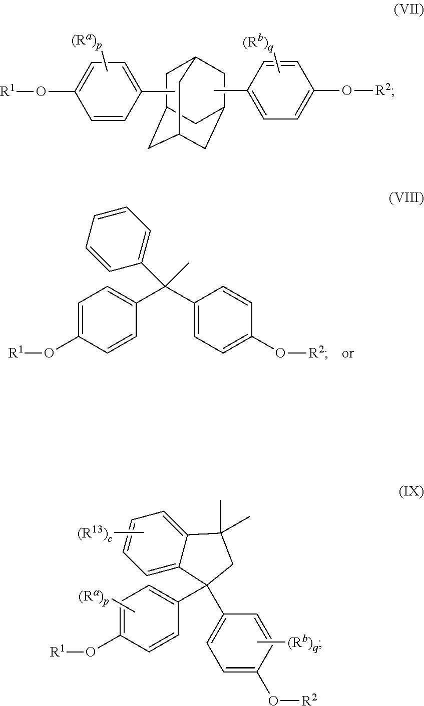

wherein R¹ and R² at each occurrence are each independently an epoxide-containing functional group; R^{a} and R^{b} at each occurrence are each independently halogen, C₁-C₁₂ alkyl, C₂-C₁₂ alkenyl, C₃-C₈ cycloalkyl, or C₁-C₁₂ alkoxy; p and q at each occurrence are each independently 0 to 4; R¹³ at each occurrence is independently a halogen or a C₁-C₆ alkyl group; c at each occurrence is independently 0 to 4; R¹⁴ at each occurrence is independently a C₁-C₆ alkyl, phenyl, or phenyl substituted with up to five halogens or C₁-C₆ alkyl groups; R^{g} at each occurrence is independently C₁-C₁₂ alkyl or halogen, or two R^{g} groups together with the carbon atoms to which they are attached form a four-, five, or six-membered cycloalkyl group; and t is 0 to 10; and a hardener; wherein the matrix composition comprises 20 to 60 total weight percent of the composite, preferably 20 to 40 total weight percent, preferably 30 to 50 total weight percent of the composite; and wherein a cured sample of the matrix composition has a glass transition temperature of greater than or equal to 200° C.; and a cured, laminated sample of the composite has a flexural strength of greater than 850 MPa measured as per ASTM D7264; and a flexural modulus of greater than 65 GPa measured as per ASTM D7264.

### Embodiment 2

The composite of Embodiment 1, wherein R¹ and R² at each occurrence are each independently:

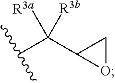

wherein R^{3a} and R^{3b} are each independently hydrogen or C₁-C₁₂ alkyl.

### Embodiment 3

The composite of any one of Embodiments 1 to 2, wherein the high heat epoxy compound has the formula (1-a), (2-a), or (4-b)

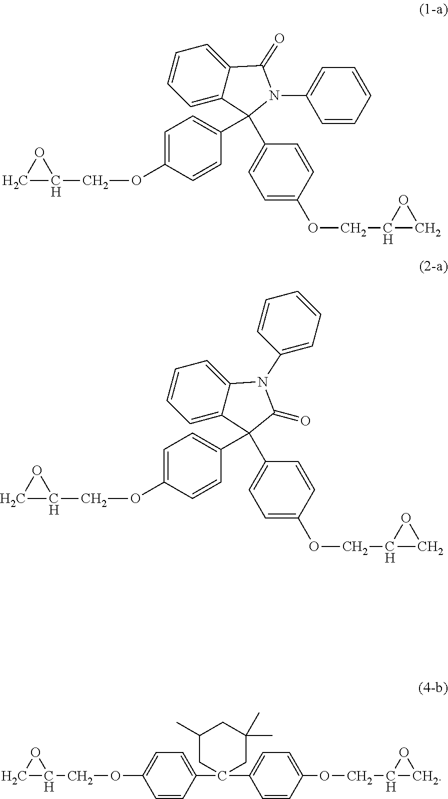 [SMILES: O=C1c2ccccc2C(c2ccc(OCC3CO3)cc2)(c2ccc(OCC3CO3)cc2)N1c1ccccc1 ; O=C1N(c2ccccc2)c2ccccc2C1(c1ccc(OCC2CO2)cc1)c1ccc(OCC2CO2)cc1 ; CC1CC(C)(C)CC(c2ccc(OCC3CO3)cc2)(c2ccc(OCC3CO3)cc2)C1]

### Embodiment 4

The composite of any one or more of Embodiments 1 to 3, wherein the substrate comprises a woven fabric, non-woven fabric, plain weave cloth, satin weave cloth, non-crimp fabric, unidirectional fibers, braid, tow, end, rope, or a combination comprising at least one of the foregoing.

### Embodiment 5

The composite of any one or more of Embodiments 1 to 4, wherein the substrate comprises a high modulus carbon-fiber, intermediate modulus carbon-fiber, high strength carbon-fiber, E-glass, S-glass, aramid fiber, or a combination comprising at least one of the foregoing.

### Embodiment 6

The composite of Embodiment 1, wherein the hardener is an aromatic diamine compound, preferably wherein the aromatic diamine amine compound comprises 4-aminophenyl sulfone (DDS), 4,4′-methylenedianiline, diethyltoluenediamine, 4,4′-methylenebis(2,6-diethyl)-aniline, m-phenylenediamine, p-phenylenediamine, 2,4-bis(p-aminobenzyl)aniline, 3,5-diethyltoluene-2,4-diamine, 3,5-diethyltoluene-2,6-diamine, m-xylylenediamine and p-xylylenediamine, diethyl toluene diamines, or a combination comprising at least one of the foregoing.

### Embodiment 7

The composite of any one or more of Embodiments 1 to 6, wherein the composite is cured or laminated.

### Embodiment 8

The composite of any one or more of Embodiments 1 to 7, wherein the matrix composition comprises 50 to 85 weight percent of the high heat epoxy compound and 15 to 50 weight percent of the hardener.

### Embodiment 9

A method of manufacturing a high heat epoxy prepreg, comprising coating a substrate, preferably carbon fibers, with a matrix composition comprising a compound having formula:

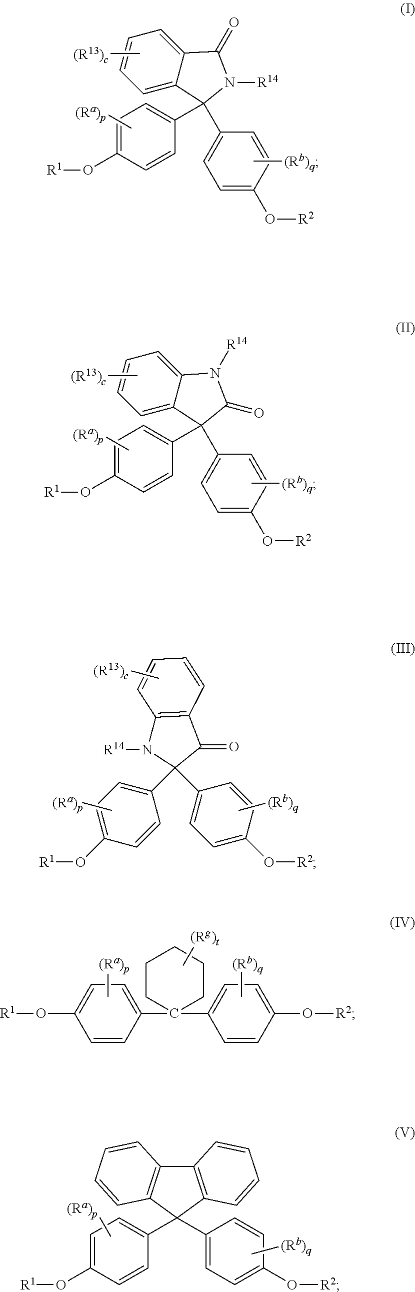

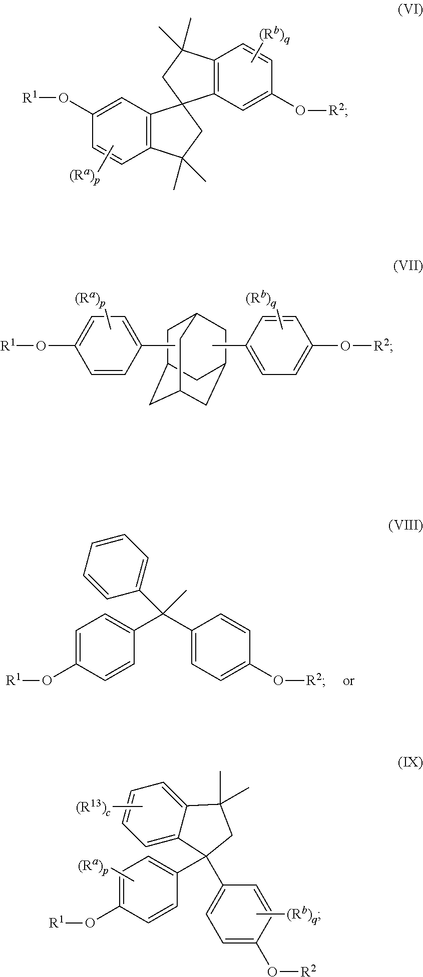

wherein R¹ and R² at each occurrence are each independently an epoxide-containing functional group; R^{a} and R^{b} at each occurrence are each independently halogen, C₁-C₁₂ alkyl, C₂-C₁₂ alkenyl, C₃-C₈ cycloalkyl, or C₁-C₁₂ alkoxy; p and q at each occurrence are each independently 0 to 4; R¹³ at each occurrence is independently a halogen or a C₁-C₆ alkyl group; c at each occurrence is independently 0 to 4; R¹⁴ at each occurrence is independently a C₁-C₆ alkyl, phenyl, or phenyl substituted with up to five halogens or C₁-C₆ alkyl groups; R^{g} at each occurrence is independently C₁-C₁₂ alkyl or halogen, or two R^{g} groups together with the carbon atoms to which they are attached form a four-, five, or six-membered cycloalkyl group; and t is 0 to 10; a hardener; and optionally a solvent, to form the high heat epoxy prepreg, wherein the prepreg comprises 40 to 80 wt %, preferably 50 to 70 wt % substrate, 20 to 60 wt % matrix composition, preferably 50 to 30 wt % matrix composition, wherein the prepreg comprises 15 to 50 wt % of the compound having formula (I) to (IX), and a cured, laminated sample of the prepreg has a flexural strength of greater than 850 MPa measured as per ASTM D7264; and a flexural modulus of greater than 65 GPa measured as per ASTM D7264, a cured sample of the matrix composition has a glass transition temperature of greater than or equal to 200° C.

### Embodiment 10

The method of Embodiment 9, wherein the matrix composition comprises 10 to 26 wt % of the solvent, wherein the solvent preferably comprises dioxane.

### Embodiment 11

The method of Embodiment 9 or 10, wherein coating comprises immersing the substrate into the matrix composition, preferably for up to 30 minutes; spraying the matrix composition onto the substrate; curtain coating the substrate with the polymer solution; pouring the matrix composition onto the substrate; or a combination comprising at least one of the foregoing.

### Embodiment 12

The method of any one or more of Embodiments 9 to 11, wherein heating comprises a temperature of 25 to 100° C. for 1 to 10 hours.

### Embodiment 13

The method of any one or more of Embodiments 9 to 12, wherein the substrate comprises a woven fabric, non-woven fabric, plain weave cloth, satin weave cloth, non-crimp fabric, unidirectional fibers, braid, tow, end, rope, a high modulus carbon-fiber, intermediate modulus carbon-fiber, high strength carbon-fiber, E-glass, S-glass, aramid fiber, or a combination comprising at least one of the foregoing.

### Embodiment 14

A prepreg formed by the method of any one or more of Embodiments 9 to 13.

### Embodiment 15

A high heat epoxy composite produced by consolidating a prepreg formed by the method of any one or more of Embodiments 9 to 13.

### Embodiment 16

The composite of Embodiment 15, in the form of a laminate produced by consolidating at least two, preferably from two to one hundred layers of the prepreg under heat and pressure.

### Embodiment 17

The composite of Embodiment 16, wherein the prepreg layers are in the form of continuous unidirectional fiber-reinforced tapes.

### Embodiment 18

The composite of any one or more of Embodiments 15 to 17, wherein the composite is thermoformed to form a shape.

### Embodiment 19

The composite of any one or more of Embodiments 15 to 18, wherein a cured sample of the matrix composition has a glass transition temperature of greater than or equal to 200° C.; and a cured, laminated sample of the composite has a flexural strength of greater than 850 MPa measured as per ASTM D7264; and a flexural modulus of greater than 65 GPa measured as per ASTM D7264.

### Embodiment 20

An article comprising the composite of any one or more of Embodiments 15 to 19.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function or objectives of the compositions, methods, and articles.

The singular forms “a,” “an,” and “the” include plural referents unless the context clearly dictates otherwise. “Or” means “and/or” unless clearly indicated otherwise by context.

The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. The suffix “(s)” is intended to include both the singular and the plural of the term that it modifies, thereby including at least one of that term (e.g., the colorant(s) includes at least one colorants).

As used herein, the term “hydrocarbyl” and “hydrocarbon” refers broadly to a substituent comprising carbon and hydrogen, optionally with 1 to 3 heteroatoms, for example, oxygen, nitrogen, halogen, silicon, sulfur, or a combination thereof; “alkyl” refers to a straight or branched chain, saturated monovalent hydrocarbon group; “alkylene” refers to a straight or branched chain, saturated, divalent hydrocarbon group; “alkylidene” refers to a straight or branched chain, saturated divalent hydrocarbon group, with both valences on a single common carbon atom; “alkenyl” refers to a straight or branched chain monovalent hydrocarbon group having at least two carbons joined by a carbon-carbon double bond; “cycloalkyl” refers to a non-aromatic monovalent monocyclic or multicycle hydrocarbon group having at least three carbon atoms, “cycloalkenyl” refers to a non-aromatic cyclic divalent hydrocarbon group having at least three carbon atoms, with at least one degree of unsaturation; “aryl” refers to an aromatic monovalent group containing only carbon in the aromatic ring or rings; “arylene” refers to an aromatic divalent group containing only carbon in the aromatic ring or rings; “alkylarylene” refers to an aryl group that has been substituted with an alkyl group as defined above, with 4-methylphenylene being an exemplary alkylarylene group; “arylalkylene” refers to an alkyl group that has been substituted with an aryl group as defined above, with benzyl being an exemplary arylalkylene group; “acyl” refers to an alkyl group as defined above with the indicated number of carbon atoms attached through a carbonyl carbon bridge (—C(═O)—); “alkoxy” refers to an alkyl group as defined above with the indicated number of carbon atoms attached through an oxygen bridge (—O—); and “aryloxy” refers to an aryl group as defined above with the indicated number of carbon atoms attached through an oxygen bridge (—O—).

Unless otherwise indicated, each of the foregoing groups can be unsubstituted or substituted, provided that the substitution does not significantly adversely affect synthesis, stability, or use of the compound. The term “substituted” as used herein means that at least one hydrogen on the designated atom or group is replaced with another group, provided that the designated atom's normal valence is not exceeded. When the substituent is oxo (i.e., ═O), then two hydrogens on the atom are replaced. Combinations of substituents or variables are permissible provided that the substitutions do not significantly adversely affect synthesis or use of the compound. Exemplary groups that can be present on a “substituted” position include, but are not limited to, cyano; hydroxyl; nitro; azido; alkanoyl (such as a C₂₋₆ alkanoyl group such as acyl); carboxamido; C₁₋₆ or C₁₋₃ alkyl, cycloalkyl, alkenyl, and alkynyl (including groups having at least one unsaturated linkages and from 2 to 8, or 2 to 6 carbon atoms); C₁₋₆ or C₁₋₃ alkoxys; C₆₋₁₀ aryloxy such as phenoxy; C₁₋₆ alkylthio; C₁₋₆ or C₁₋₃ alkylsulfinyl; C₁₋₆ or C₁-3 alkylsulfonyl; aminodi(C₁₋₆ or C₁₋₃)alkyl; C₆₋₁₂ aryl having at least one aromatic rings (e.g., phenyl, biphenyl, naphthyl, or the like, each ring either substituted or unsubstituted aromatic); C₇-19 arylalkyl having 1 to 3 separate or fused rings and from 6 to 18 ring carbon atoms; or arylalkoxy having 1 to 3 separate or fused rings and from 6 to 18 ring carbon atoms, with benzyloxy being an exemplary arylalkoxy. As is typical in the art, a line extending from a structure signifies a terminating methyl group —CH₃.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A high heat epoxy composite comprising:
a substrate;
a matrix composition comprising:
a high heat epoxy compound having formula: 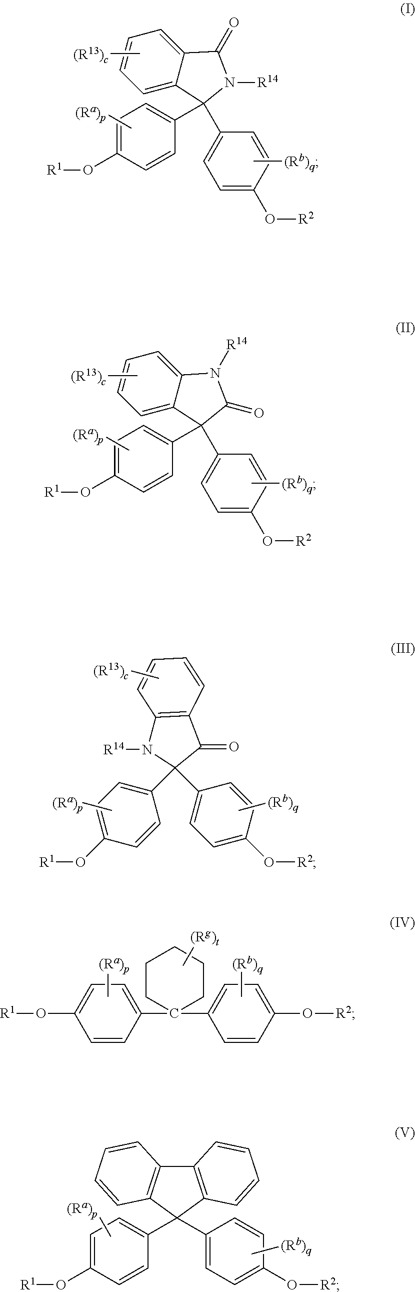 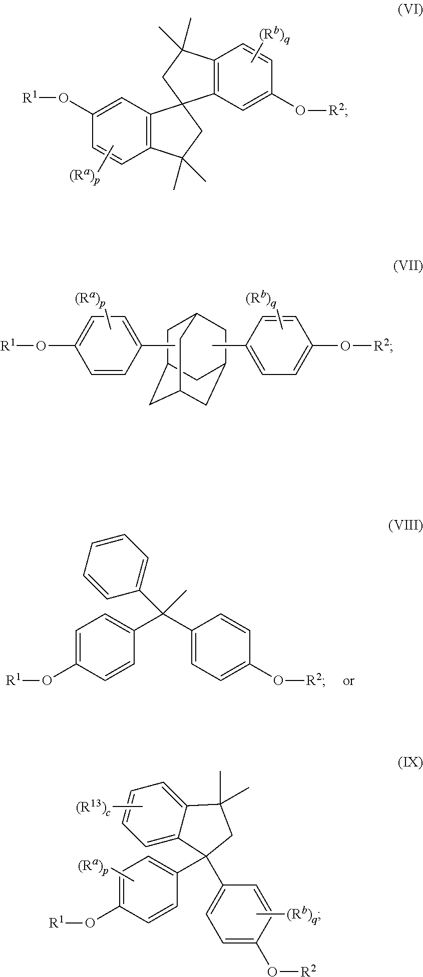
wherein
R¹ and R² at each occurrence are each independently an epoxide-containing functional group;
R^{a} and R^{b} at each occurrence are each independently halogen, C₁-C₁₂ alkyl, C₂-C₁₂ alkenyl, C₃-C₈ cycloalkyl, or C₁-C₁₂ alkoxy;
p and q at each occurrence are each independently 0 to 4; R¹³ at each occurrence is independently a halogen or a C₁-C₆ alkyl group;
c at each occurrence is independently 0 to 4; R^{H} at each occurrence is independently a C₁-C₆ alkyl, phenyl, or phenyl substituted with up to five halogens or C₁-C₆ alkyl groups;
R^{g} at each occurrence is independently C₁-C₁₂ alkyl or halogen, or two R^{g} groups together with the carbon atoms to which they are attached form a four-, five, or six-membered cycloalkyl group; and
t is 0 to 10; and
a hardener;
wherein the matrix composition comprises 20 to 60 total weight percent of the composite-; and
wherein
a cured sample of the matrix composition has a glass transition temperature of greater than or equal to 200° C., and
a cured, laminated sample of the composite has a flexural strength of greater than 850 MPa measured as per ASTM D7264; and a flexural modulus of greater than 65 GPa measured as per ASTM D7264.

2. The composite of claim 1, wherein R¹ and R² at each occurrence are each independently: 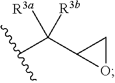
wherein R^{3a} and R^{3b} are each independently hydrogen or C₁-C₁₂ alkyl.

3. The composite of claim 1, wherein the high heat epoxy compound has the formula (1-a), (2-a), or (4-b)

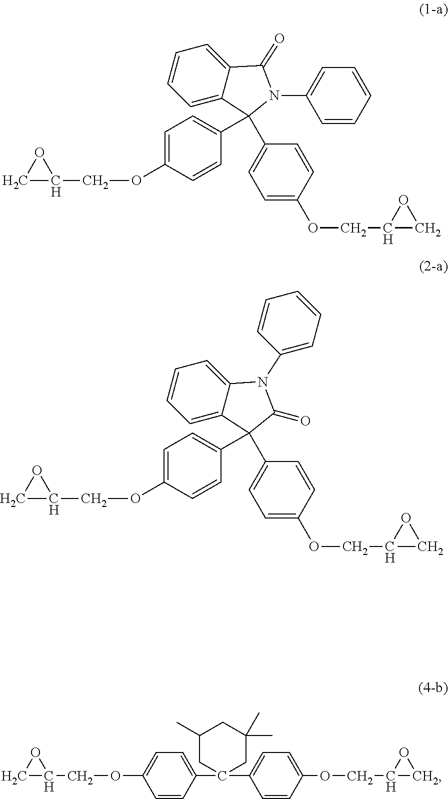 [SMILES: O=C1c2ccccc2C(c2ccc(OCC3CO3)cc2)(c2ccc(OCC3CO3)cc2)N1c1ccccc1 ; O=C1N(c2ccccc2)c2ccccc2C1(c1ccc(OCC2CO2)cc1)c1ccc(OCC2CO2)cc1 ; CC1CC(C)(C)CC(c2ccc(OCC3CO3)cc2)(c2ccc(OCC3CO3)cc2)C1]

4. The composite of claim 1, wherein the substrate comprises a woven fabric, non-woven fabric, plain weave cloth, satin weave cloth, non-crimp fabric, unidirectional fibers, braid, tow, end, rope, or a combination comprising at least one of the foregoing.

5. The composite of claim 1, wherein the substrate comprises a high modulus carbon-fiber, intermediate modulus carbon-fiber, high strength carbon-fiber, E-glass, S-glass, aramid fiber, or a combination comprising at least one of the foregoing.

6. The composite of claim 1, wherein the hardener is an aromatic diamine compound, preferably wherein the aromatic diamine amine compound comprises 4-aminophenyl sulfone (DDS), 4,4′-methylenedianiline, diethyltoluenediamine, 4,4′-methylenebis(2,6-diethyl)-aniline, m-phenylenediamine, p-phenylenediamine, 2,4-bis(p-aminobenzyl)aniline, 3,5-diethyltoluene-2,4-diamine, 3,5-diethyltoluene-2,6-diamine, m-xylylenediamine and p-xylylenediamine, diethyl toluene diamines, or a combination comprising at least one of the foregoing.

7. The composite of claim 1, wherein the composite is cured or laminated.

8. The composite of claim 1, wherein the matrix composition comprises 50 to 85 weight percent of the high heat epoxy compound and 15 to 50 weight percent of the hardener.

9. A method of manufacturing a high heat epoxy prepreg, comprising
coating a substrate with a matrix composition comprising
a compound having formula: 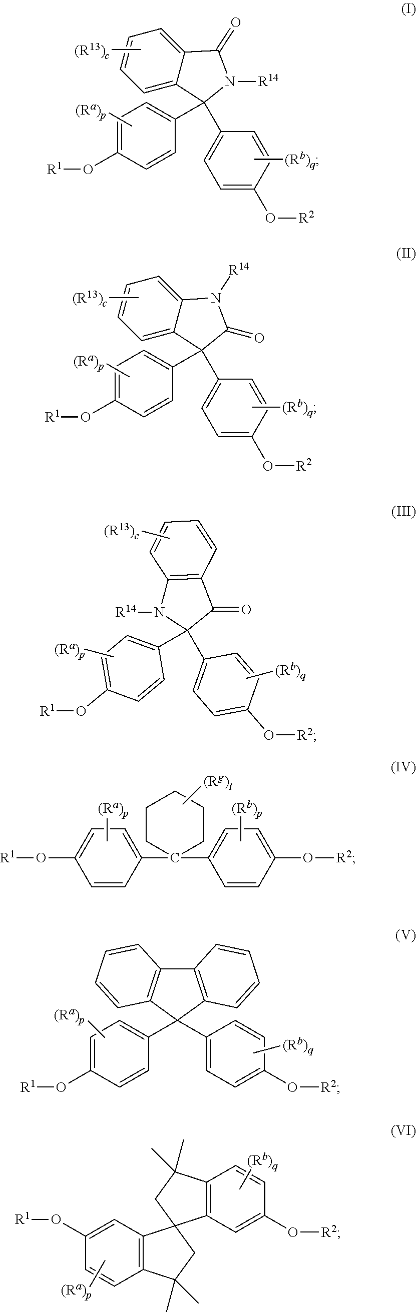 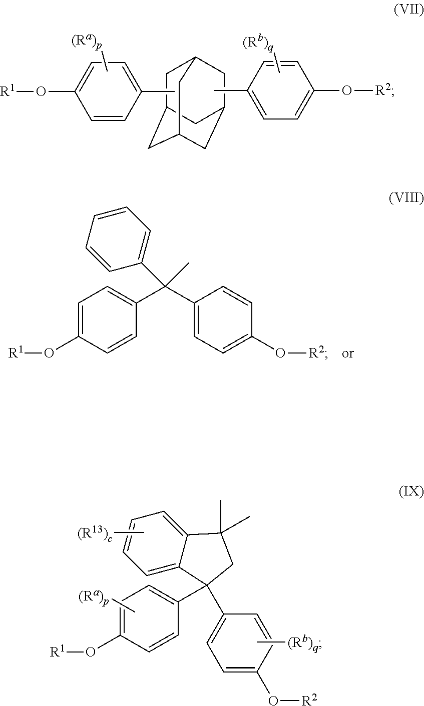
wherein
R¹ and R² at each occurrence are each independently an epoxide-containing functional group;
R^{a} and R^{b} at each occurrence are each independently halogen, C₁-C₁₂ alkyl, C₂-C₁₂ alkenyl, C₃-C₈ cycloalkyl, or C₁-C₁₂ alkoxy;
p and q at each occurrence are each independently 0 to 4;
R¹³ at each occurrence is independently a halogen or a C₁-C₆ alkyl group;
c at each occurrence is independently 0 to 4;
R¹⁴ at each occurrence is independently a C₁-C₆ alkyl, phenyl, or phenyl substituted with up to five halogens or C₁-C₆ alkyl groups;
R^{g} at each occurrence is independently C₁-C₁₂ alkyl or halogen, or two R^{g} groups together with the carbon atoms to which they are attached form a four-, five, or six-membered cycloalkyl group; and
t is 0 to 10;
a hardener; and
optionally a solvent, to form the high heat epoxy prepreg,
wherein
the prepreg comprises
40 to 80 wt %, substrate,
20 to 60 wt % matrix composition, wherein the prepreg comprises 15 to 50 wt % of the compound having formula (I) to (IX), and
wherein
a cured, laminated sample of the prepreg has a flexural strength of greater than 850 MPa measured as per ASTM D7264 and a flexural modulus of greater than 65 GPa measured as per ASTM D7264, and
a cured sample of the matrix composition has a glass transition temperature of greater than or equal to 200° C.

10. The method of claim 9, wherein the matrix composition comprises 10 to 26 wt % of the solvent.

11. The method of claim 9, wherein coating comprises immersing the substrate into the matrix composition minutes; spraying the matrix composition onto the substrate; curtain coating the substrate with the polymer solution; pouring the matrix composition onto the substrate; or a combination comprising at least one of the foregoing.

12. The method of claim 9, wherein heating comprises a temperature of 25 to 100° C. for 1 to 10 hours.

13. The method of claim 9, wherein the substrate comprises a woven fabric, non-woven fabric, plain weave cloth, satin weave cloth, non-crimp fabric, unidirectional fibers, braid, tow, end, rope, a high modulus carbon-fiber, intermediate modulus carbon-fiber, high strength carbon-fiber, E-glass, S-glass, aramid fiber, or a combination comprising at least one of the foregoing.

14. A prepreg formed by the method of claim 9.

15. A high heat epoxy composite produced by consolidating a prepreg formed by the method of claim 9.

16. The composite of claim 15, in the form of a laminate produced by consolidating at least two of the prepreg under heat and pressure.

17. The composite of claim 16, wherein the prepreg layers are in the form of continuous unidirectional fiber-reinforced tapes.

18. The composite of claim 15, wherein the composite is thermoformed to form a shape.

19. The composite of claim 15, wherein
a cured sample of the matrix composition has a glass transition temperature of greater than or equal to 200° C.; and
a cured, laminated sample of the composite has
a flexural strength of greater than 850 MPa measured as per ASTM D7264; and
a flexural modulus of greater than 65 GPa measured as per ASTM D7264.

20. An article comprising the composite of claim 15.
